(19) United States
(12) Patent Application Publication
(10) Pub. No.: US 2012/0077563 A1
(43) Pub. Date: Mar. 29, 2012

(54) METHOD OF DISPLAYING SELECTED SYMBOLS TO A PLAYER

(75) Inventors: Daniel Julio Montenegro, Endeavour Hills (AU); Neal Anthony Porter, Mount Eliza (AU)

(73) Assignee: Aristocrat Technologies Australia PTY Limited, North Ryde (AU)

(21) Appl. No.: 13/075,986

(22) Filed: Mar. 30, 2011

(30) Foreign Application Priority Data
Mar. 30, 2010 (AU) 2010901338

(51) Int. Cl. A63F 13/00

(52) U.S. Cl. 463/20

(57) ABSTRACT

There is disclosed a gaming system including: a display for displaying a plurality of rows of display positions; a representation display controller arranged to control the display to display a representation of changing symbols in each display position of the plurality of rows of display positions; a symbol selector arranged to select a plurality of symbols from a set of symbols for display in a first row of the plurality of rows of display positions; and a symbol display controller arranged to control the display to simultaneously display the selected symbols in the display positions of the first row of display positions while representations of changing symbols are being displayed in display positions other than the display positions of the first row of display positions.

### CROSS REFERENCE TO RELATED APPLICATIONS

The present application relates to and claims the benefit of priority from Australian Provisional Patent Application Number 2010901338, filed on Mar. 30, 2010, which is herein incorporated by reference in its entirety.

### FIELD OF THE INVENTION

The present invention relates to a method of displaying selected symbols to a player, a gaming system for displaying selected symbols to a player, a game controller for controlling a display to display selected symbols to a player, and a gaming machine for displaying selected symbols to a player.

### BACKGROUND

It is known that either a mechanical display or a video display may be used to implement a spinning-reel type game. In gaming machines that use mechanical displays, a motor is often used to spin each reel. These machines are sometimes referred to as “stepper” machines. In gaming machines that use video displays, the mechanical reels are usually replaced with virtual reels displayed on a Cathode Ray Tube (CRT) monitor.

In a standard 3×3 spinning-reel type game, three reels are usually displayed to a player, each of the reels corresponding to a column of three display positions. Typically, a game starts when a player causes the reels to spin, and the game ends when the spinning reels stops to reveal a symbol for each display position of each reel.

### SUMMARY

In accordance with a first aspect of the invention, there is provided a method of displaying selected symbols to a player in a game of the type wherein a plurality of symbols are selected from a set of symbols and a game outcome is determined based on the selected symbols, the method including:

displaying a plurality of rows of display positions;

displaying a representation of changing symbols in each display position of the plurality of rows of display positions;

selecting a plurality of symbols from a set of symbols for display in a first row of the plurality of rows of display positions; and

simultaneously displaying the selected symbols in the display positions of the first row of display positions while representations of changing symbols are being displayed in display positions other than the display positions of the first row of display positions.

In an embodiment, each row of display positions includes a plurality of horizontally adjacent display positions.

In an embodiment, the method includes making an award to the player when the selected symbols displayed in the first row of display positions correspond to a winning combination.

In an embodiment, displaying a plurality of rows of display positions includes displaying three or more rows of display positions.

In an embodiment, the method further includes:

selecting a plurality of symbols from the set of symbols for display in a second row of the plurality of rows of display positions; and

simultaneously displaying the selected symbols in the display positions of the second row of display positions while representations of changing symbols are being displayed in display positions other than the first and second rows of display positions.

In an embodiment, displaying a plurality of rows of display positions includes displaying two rows of display positions.

In an embodiment, the method further includes:

selecting a plurality of symbols from the set of symbols for display in a second row of the plurality of rows of display positions; and

simultaneously displaying the selected symbols in the display positions of the second row of display positions.

In an embodiment, the method further includes:

selecting a row of display positions from the plurality of rows of display positions as the first row of display positions; and

selecting another row of display positions from the plurality of rows of display positions as the second row of display positions.

In an embodiment, the first and second rows of display positions are selected randomly from the plurality of rows of display positions.

In an embodiment, the first and second rows of display positions are selected from the plurality of rows of display positions based on a predetermined sequence.

In an embodiment, the plurality of rows of display positions are displayed one on top of another, the first row of display positions includes all the display positions of the bottom most row of the plurality of rows of display positions, and the second row of display positions includes all the display positions of the second bottom most row of the plurality of rows of display positions.

In an embodiment, the representation of changing symbols displayed in each display position is a representation of spinning symbols.

In an embodiment, the game is a spinning-reel type game.

In accordance with a second aspect of the invention, there is provided a gaming system including:

a display for displaying a plurality of rows of display positions;

a representation display controller arranged to control the display to display a representation of changing symbols in each display position of the plurality of rows of display positions;

a symbol selector arranged to select a plurality of symbols from a set of symbols for display in a first row of the plurality of rows of display positions; and

a symbol display controller arranged to control the display to simultaneously display the selected symbols in the display positions of the first row of display positions while representations of changing symbols are being displayed in display positions other than the display positions of the first row of display positions.

In an embodiment, each row of display positions includes a plurality of horizontally adjacent display positions.

In an embodiment, the gaming system further includes:

an outcome evaluator arranged to evaluate whether or not the selected symbols for display in the first row of display positions correspond to a winning combination; and

a prize awarder arranged to make an award to the player when the selected symbols displayed in the first row of display positions correspond to a winning combination.

In an embodiment, the display is arranged to display three or more rows of display positions.

In an embodiment, the symbol selector is arranged to select a plurality of symbols from the set of symbols for display in a second row of the plurality of rows of display positions, and the symbol display controller is arranged to control the display to simultaneously display the selected symbols in the display positions of the second row of display positions while representations of changing symbols are being displayed in display positions other than the first and second rows of display positions.

In an embodiment, the display is arranged to display two rows of display positions.

In an embodiment, the symbol selector is arranged to select a plurality of symbols from the set of symbols for display in a second row of the plurality of rows of display positions, and the symbol display controller is arranged to control the display to simultaneously display the selected symbols in the display positions of the second row of display positions.

In an embodiment, the symbol selector is arranged to select a row of display positions from the plurality of rows of display positions as the first row of display positions, and to select another row of display positions from the plurality of rows of display positions as the second row of display positions.

In an embodiment, the symbol selector is arranged to select the first and second rows of display positions randomly from the plurality of rows of display positions.

In an embodiment, the symbol selector is arranged to select the first and second rows of display positions from the plurality of rows of display positions based on a predetermined sequence.

In an embodiment, the display is arranged to display the plurality of rows of display positions one on top of another, the first row of display positions includes all the display positions of the bottom most row of the plurality of rows of display positions, and the second row of display positions includes all the display positions of the second bottom most row of the plurality of rows of display positions.

In an embodiment, the representation of changing symbols displayed in each display position by the representation display controller is a representation of spinning symbols.

In accordance with a third aspect of the invention, there is provided a game controller for a gaming system, the game controller configured to:

control a display to display a plurality of rows of display positions;

control the display to display a representation of changing symbols in each display position of the plurality of rows of display positions;

select a plurality of symbols from a set of symbols for display in a first row of the plurality of rows of display positions; and

control the display to simultaneously display the selected symbols in the display positions of the first row of display positions while representations of changing symbols are being displayed in display positions other than the display positions of the first row of display positions.

In an embodiment, each row of display positions includes a plurality of horizontally adjacent display positions.

In an embodiment, the game controller is configured to make an award to the player when the selected symbols displayed in the first row of display positions correspond to a winning combination.

In an embodiment, the game controller is configured to control the display to display a plurality of rows of display positions by displaying three or more rows of display positions.

In an embodiment, the game controller is configured to:

select a plurality of symbols from the set of symbols for display in a second row of the plurality of rows of display positions; and

control the display to simultaneously display the selected symbols in the display positions of the second row of display positions while representations of changing symbols are being displayed in display positions other than the display positions of the first and second rows of display positions.

In an embodiment, the game controller is configured to control the display to display a plurality of rows of display positions by displaying two rows of display positions.

In an embodiment, the game controller is configured to:

select a plurality of symbols from the set of symbols for display in a second row of the plurality of rows of display positions; and

control the display to simultaneously display the selected symbols in the display positions of the second row of display positions.

In an embodiment, the game controller is configured to:

select a row of display positions from the plurality of rows of display positions as the first row of display positions; and

select another row of display positions from the plurality of rows of display positions as the second row of display positions.

In an embodiment, the first and second rows of display positions are selected randomly from the plurality of rows of display positions.

In an embodiment, the first and second rows of display positions are selected from the plurality of rows of display positions based on a predetermined sequence.

In an embodiment, the plurality of rows of display positions are displayed one on top of another, the first row of display positions includes all the display positions of the bottom most row of the plurality of rows of display positions, and the second row of display positions includes all the display positions of the second bottom most row of the plurality of rows of display positions.

In an embodiment, the representation of changing symbols displayed in each display position is a representation of spinning symbols.

In an embodiment, the game is a spinning-reel type game.

In accordance with a fourth aspect of the invention, there is provided a gaming machine including:

a display for displaying a plurality of rows of display positions; and

a game controller including:
a representation display controller arranged to control a display to display a representation of changing symbols in each display position of the plurality of rows of display positions;
a symbol selector arranged to select a plurality of symbols from a set of symbols for display in a first row of the plurality of rows of display positions; and
a symbol display controller arranged to control a display to simultaneously display the selected symbols in the display positions of the first row of display positions while representations of changing symbols are being displayed in display positions other than the display positions of the first row of display positions.

In accordance with a fifth aspect of the invention, there is provided computer program code which when executed implements the above method.

In accordance with a sixth aspect of the invention, there is provided a tangible computer readable medium including the above computer program code.

The invention also extends to a data signal including the above computer program code.

### BRIEF DESCRIPTION OF DRAWINGS

One or more embodiments of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a block diagram of an example of a gaming system for displaying selected symbols to a player; and

FIG. 7 is a flow chart of an example of a method of displaying selected symbols to a player; and

FIGS. 8A to 8E are diagrammatic representations of an example of display positions and selected symbols that are displayed to a player in a game.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Referring to the drawings, there is shown a gaming system arranged to implement a game of the type wherein a plurality of symbols are selected from a set of symbols and a game outcome is determined based on the selected symbols. An example of a game of this type is a spinning-reel type game.

As will be further described below, the gaming system is arranged to display selected symbols to a player in the game. Firstly, a plurality of rows of display positions is displayed to the player. Then, a representation of changing symbols is displayed in each display position of the plurality of rows of display positions. After this, a plurality of symbols are selected for one of the rows of display positions and these selected symbols are then simultaneously displayed while representations of changing symbols remain being displayed in display positions other than the display positions of the row of display positions.

### General Construction of Gaming System

The gaming system can take a number of different forms. In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

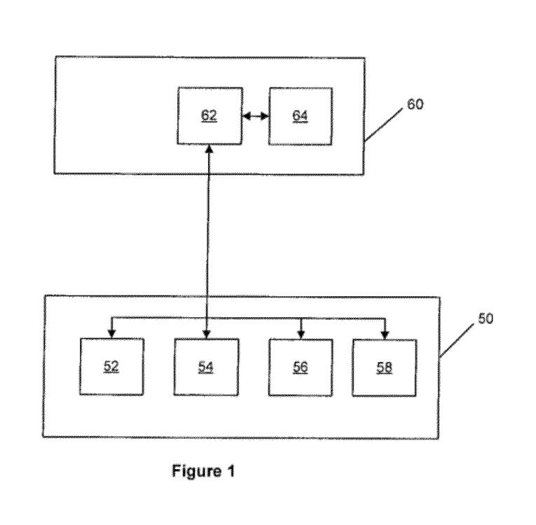

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

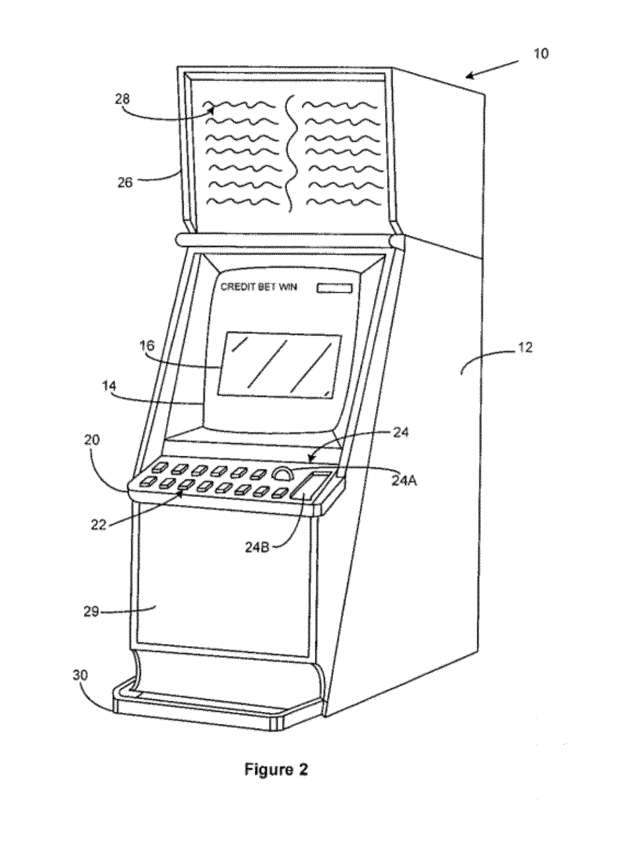

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may have a ticket reader for reading tickets having a value and crediting the player based on the face value of a ticket. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

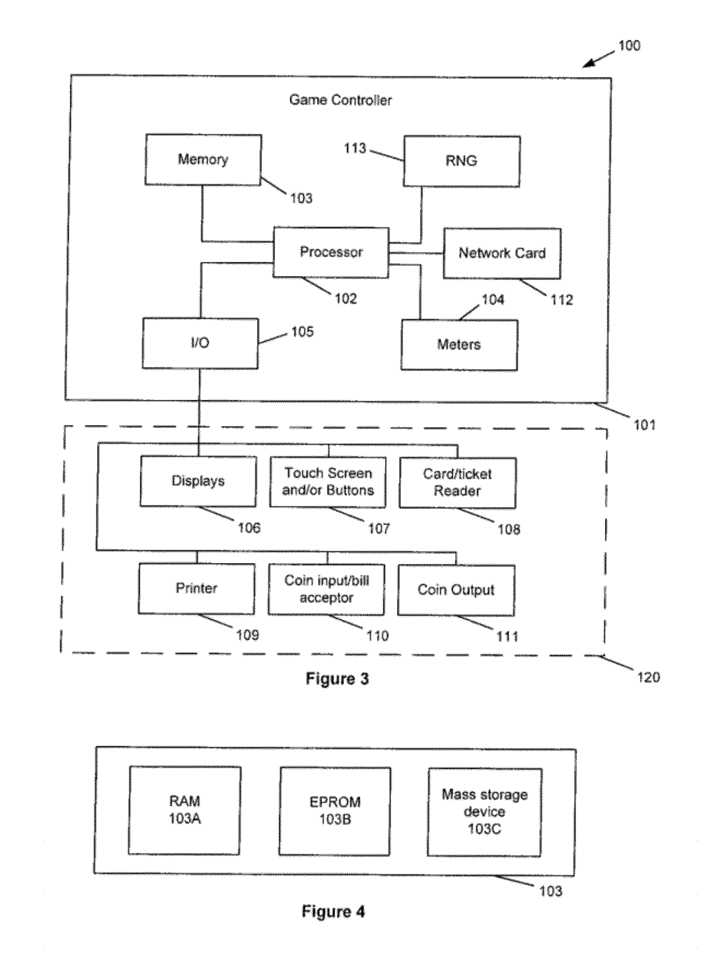

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

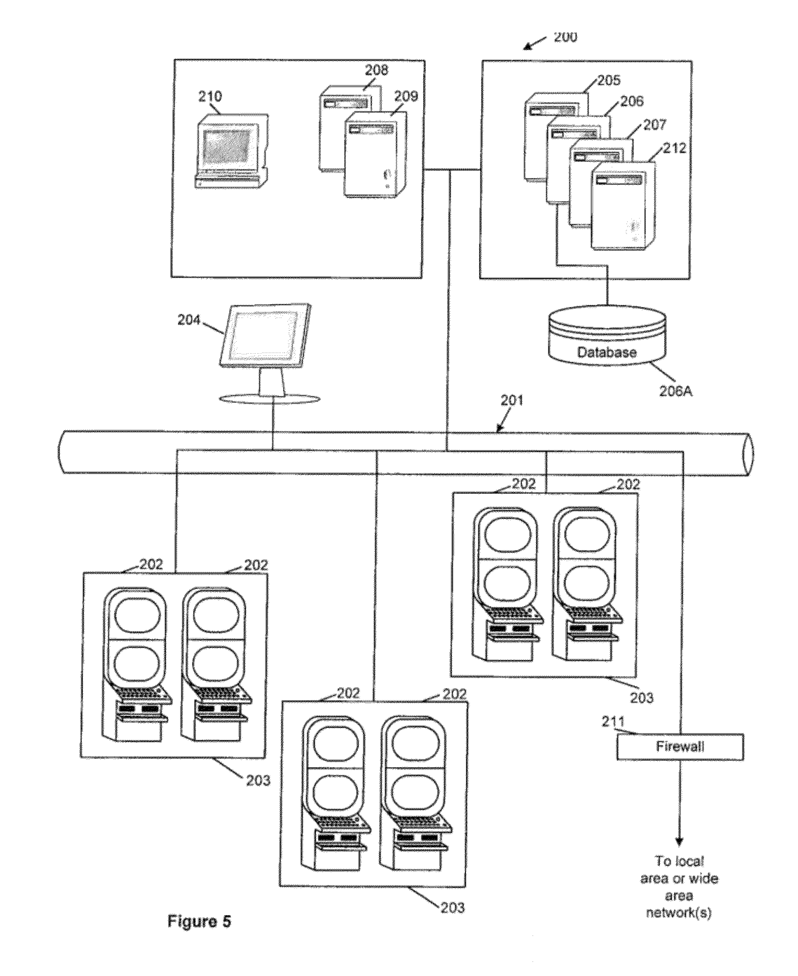

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

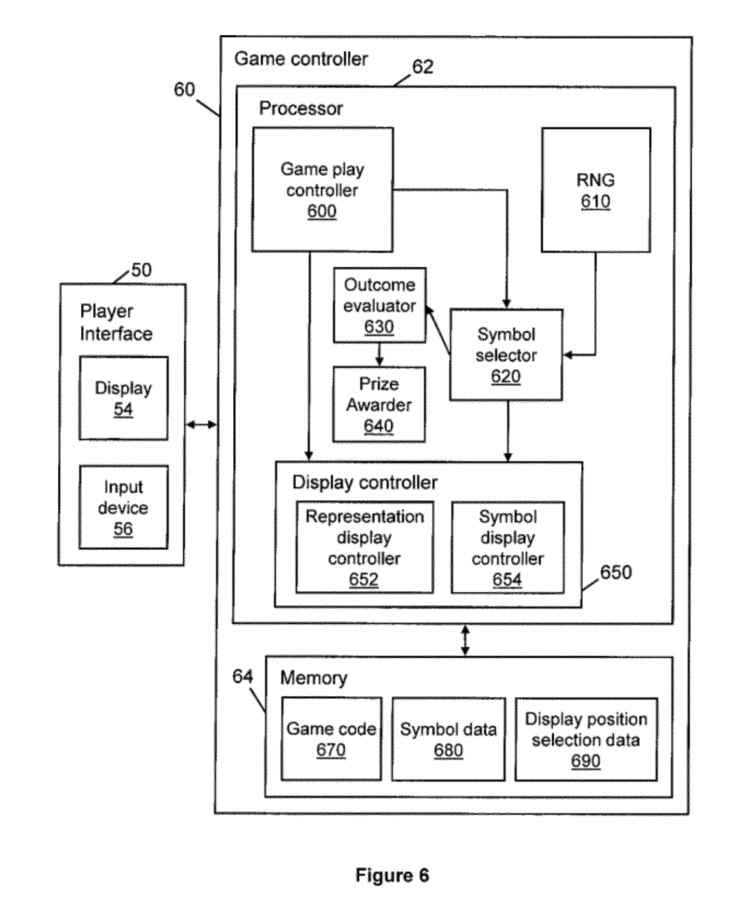

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements, rules, guidelines, and/or preferences for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

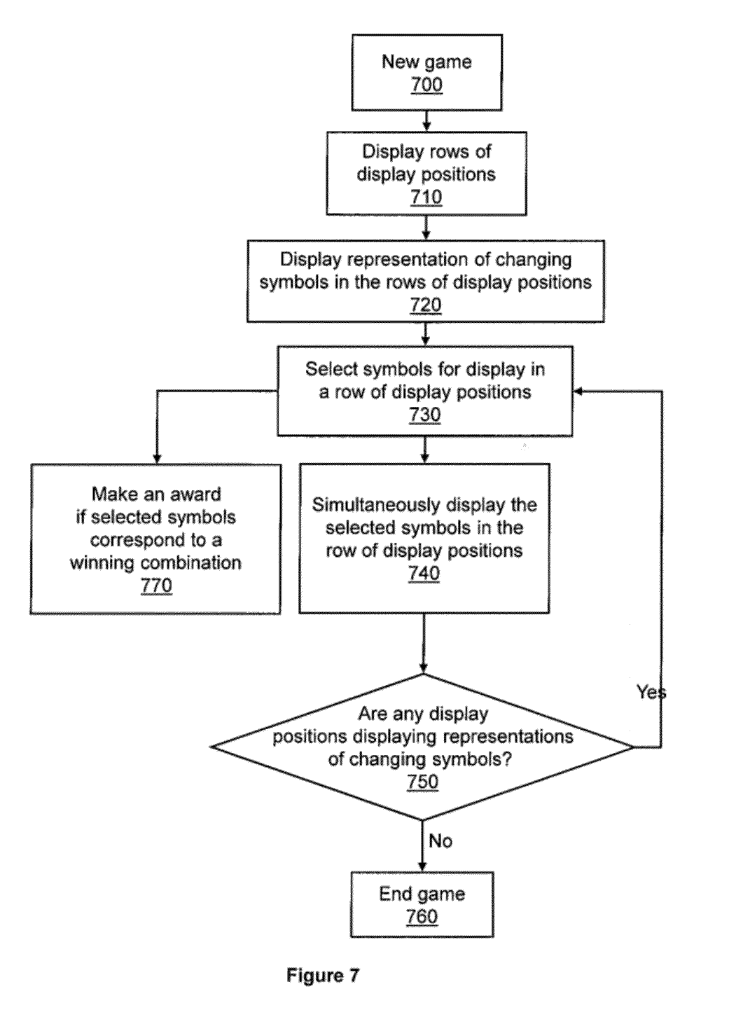

FIG. 6 shows the functional components of an example of the gaming system. As shown in the figure, a game controller 60 including a processor 62 is arranged to implement a number of modules based on program code and data stored in memory 64 so as to display selected symbols to a player in a game.

Persons skilled in the art will appreciate that the modules are typically implemented using a processor based on program code and data stored in memory but that one or more of the modules could alternatively be implemented in some other way, for example, by a dedicated circuit.

In this example, the game is a spinning-reel type game wherein a plurality of symbols is selected from a set of symbols and a game outcome is determined based on the selected symbols. In this spinning-reel type game, a plurality of display positions is displayed to the player. Persons skilled in the art will appreciate that the spinning-reel type game may vary in terms of the number of display positions that are displayed to a player; for example, the game may be a 4×6 spinning-reel type game wherein a total of 24 display positions are displayed to a player, a 3×5 spinning-reel type game wherein a total of 15 display positions are displayed to a player, a 4×5 spinning-reel type game wherein a total of 20 display positions are displayed to a player etc.

As illustrated in FIG. 6, memory 64 includes game code or program code 670 for implementing the modules. Memory 64 also includes, for use by the modules, symbol data 680 and display position selection data 690. The symbol data 680 includes a plurality of symbols that may be selected in a game. The display position selection data 690 includes one or more predetermined pluralities of display positions that may be selected in a game. Persons skilled in the art will appreciate that symbol data 680 and/or the display position selection data 690 may in another example be implemented in a separate device, for example, in a data server.

The modules implemented by the processor 62 include a game play controller 600 and a Random Number Generator (RNG) 610. The game play controller 600 is arranged to conduct the spinning-reel type game based on instructions from an input device 56 of a player interface 50 operated by the player. The Random Number Generator (RNG) 610 is arranged to generate random numbers (including pseudo-random numbers). Persons skilled in the art will appreciate that the RNG 610 may in another example be implemented in a separate device, for example, in a Random Number Generator server.

A display 54 of the player interface 50 is arranged to display a plurality of rows of display positions of the spinning-reel type game to the player. A display controller 650 implemented by the processor 62 of the game controller 60 is arranged to control the display 54. It is envisaged that a row of display positions includes a plurality of horizontally adjacent display positions. For example, in a 4×6 spinning-reel type game having 24 display positions, a row of display positions may be an entire one out of the 4 rows (that is, a row made up of all of the 6 horizontally adjacent display positions that make up the row) or may be only part of one of the 4 rows (for example, a row made up of only 3 horizontally adjacent display positions).

The processor 62 also implements a symbol selector 620, an outcome evaluator 630, and a prize awarder 640. The symbol selector 620 is arranged to select a row of display positions. In this example, the symbol selector 620 can make this row selection either randomly based on random numbers from the RNG 610 or based on a predetermined sequence from the display position selection data 690. The symbol selector 620 is also arranged to obtain from the RNG 610 random numbers to select a plurality of symbols from the symbol data 680 for display in the row of display positions selected from the plurality of rows of display positions. It is envisaged that in another example, the gaming system may be arranged such that row selection can be carried out only randomly or only based on a predetermined sequence (in contrast to the gaming system of this example where row selection can be carried out either randomly or based on a predetermined sequence).

The outcome evaluator 630 is arranged to obtain the selected symbols from the symbol selector 620 and to evaluate whether the selected symbols correspond to a winning combination. The outcome evaluator 630 communicates with a prize awarder 640 arranged to make an award to the player when the selected symbols correspond to a winning combination. Persons skilled in the art will appreciate that a winning combination may be predetermined, selected by a player, allocated according to game rules etc. Persons skilled in the art will also appreciate that winning combinations include horizontal win lines, vertical win lines, diagonal win lines, or non-linear combinations of symbols. Examples of awards include monetary prizes, free games, bonus credits etc.

In this example, the game play controller 600 and the symbol selector 620 communicate to the display controller 650 which includes a representation display controller 652 and a symbol display controller 654.

The representation display controller 652 is arranged to control the display 54 to display a representation of changing symbols in each display position of the plurality of rows of display positions. It is envisaged that the game play controller 600 typically communicates to the representation display controller 652 to display a representation of changing symbols in each display position when a new game starts. Persons skilled in the art will appreciate that the representation of changing symbols includes a representation of a set of symbols cycling through each display position, a representation of a spinning symbol or spinning symbols, a representation of scrolling symbols etc.

The symbol display controller 654 is arranged to obtain the symbols selected by the symbol selector 620 and to control the display 54 to simultaneously display the selected symbols in the display positions of the row of display positions selected by the symbol selector 620 while representations of changing symbols are still being displayed in display positions other than the selected row of display positions. The symbol display controller 654 is arranged to control the display 54 to simultaneously display the symbols selected by the symbol selector 620 in this manner until representations of changing symbols are displayed in only a last row (or last one) of the display positions after which the symbol display controller 654 is arranged to control the display 54 to simply display the selected symbol(s) for the remaining display position(s) still displaying representation(s) of changing symbols. Persons skilled in the art will appreciate that the simultaneous display of selected symbols may be carried out in a variety of ways including as synchronized stopping of spinning symbols to the selected symbols.

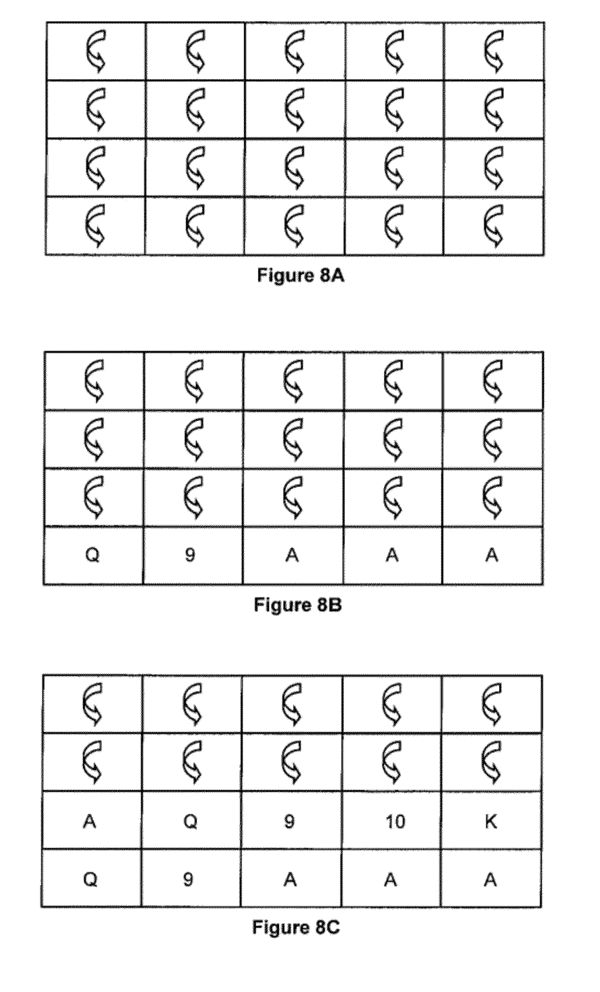

FIG. 7 is a flow diagram representative of example machine readable instructions that can be executed to implement one or more of the example systems shown and described herein and/or portions of one or more of those systems. The example process(es) of FIG. 7 can be performed using a processor, a controller and/or any other suitable processing device, such as the game controller 60 and/or other component of system 10. For example, the example process(es) of FIG. 7 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 7 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 7 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 7 can be implemented manually or as any combination(s) of any of the foregoing techniques, for example, any combination of firmware, software, discrete logic and/or hardware. Further, although the example process(es) of FIG. 7 are described with reference to the flow diagram of FIG. 7, other methods of implementing the process(es) of FIG. 7 can be employed. For example, the order of execution of the blocks can be changed, and/or some of the blocks described can be changed, eliminated, sub-divided, or combined. Additionally, any or all of the example process(es) of FIG. 7 can be performed sequentially and/or in parallel by, for example, separate processing threads, processors, devices, discrete logic, circuits, etc.

FIG. 7 is a flowchart illustrating an example of the method of displaying selected symbols to a player in a spinning-reel type game.

At block 700, a new spinning-reel type game is started by a player using the input device 56 of the player interface 50. At block 710, the display controller 650 controls the display 54 of the player interface 50 so that a plurality of rows of display positions is displayed to the player. At block 720, the representation display controller 652 controls the display 54 to display to the player a representation of changing symbols in each of the display positions of the plurality of rows of display positions. At block 730, the symbol selector 620 obtains random numbers from the RNG 610 to select symbols from symbol data 680 for a row of display positions. In one example, the symbol selector 620 selects the row of display positions randomly based on one or more random numbers from the RNG 610. In another example, the symbol selector 620 selects the row of display positions based on a predetermined sequence from the display position selection data 690.

After the row of display positions and the symbols for the row of display positions have been selected by the symbol selector 620, the symbol display controller 654 controls the display 54 to simultaneously display the selected symbols in the row of display positions and the outcome evaluator 630 evaluates whether or not the selected symbols in the row of display positions correspond to a winning combination. If the selected symbols in the row of display positions correspond to a winning combination, the prize awarder 640 makes an award to the player at block 770. At block 750, the game play controller 600 determines whether or not any of the display positions in the game are still displaying representations of changing symbols. If the answer is yes, blocks 730 and 740 (and if the selected symbols correspond to another winning combination, block 770) are repeated. That is, the symbols selector 620 selects symbols for a second row of display positions, the symbol display controller 654 controls the display 54 to simultaneously display the selected symbols in the second row of display positions, the outcome evaluator 630 evaluates whether or not the selected symbols in the second row of display positions correspond to a winning combination, and if the selected symbols in the second row of display positions correspond to a winning combination, the prize awarder 640 makes an award to the player.

Blocks 730, 740 and 750 (and if the selected symbols correspond to another winning combination, block 770) are repeated until selected symbols are displayed in all of the display positions of the spinning-reel game (that is, until none of the display positions continue to display representations of changing symbols) and the game ends at block 760.

Further aspects of the method will be apparent from the above description of the gaming system. Persons skilled in the art will also appreciate that the method could be embodied in program code. The program code could be supplied in a number of ways, for example on a computer readable storage medium, such as a disc or a memory (for example, that could replace part of memory 103) or as a data signal (for example, by transmitting it from a server).

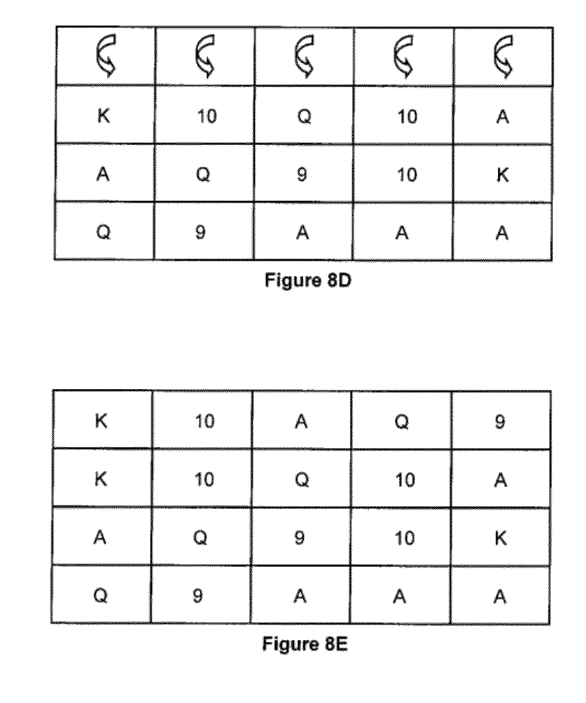

FIGS. 8A to 8E illustrate an example of selected symbols being displayed on the display 54 of the player interface 50 to a player in a 4×5 spinning-reel type game having 20 display positions. As illustrated by these figures, the 4×5 spinning-reel type game includes a total of 4 rows of display positions, each of these 4 rows having a total of 5 horizontally adjacent display positions.

As illustrated in FIG. 8A, a representation of changing symbols is displayed in each of the 20 display positions when a new game starts. In this example, each representation of changing symbols is displayed as a spinning symbol typically displayed in spinning-reel type games.

While representations of changing symbols are being displayed in all the display positions, symbols for a row of display positions are selected by the symbol selector 620 implemented by the processor 62 of the game controller 60 based on symbol data 680. The representation display controller 652 simultaneously displays the selected symbols after the symbol selector 620 selects the symbols as illustrated in FIG. 8B. In this example, the row of display positions selected by the symbol selector 620 is the bottom most row of display positions and the selected symbols are Q, 9, A, A and A. In this example, the symbol selector 620 selects the row of display positions based on a predetermined sequence from the display position selection data 690 which specifies that the bottom most row is the row to be selected. After the symbols for the bottom most row of display positions have been selected by the symbol selector 620, the outcome evaluator 630 evaluates that the three “A” symbols arranged in a row in the selected symbols correspond to a winning combination and accordingly, the prize awarder 640 makes an award to the player.

The symbols selector 620 then selects another row of display positions based on a predetermined sequence from the display position selection data 690. In this case, the display position selection data 690 specifies that the next row to be selected is the second bottom most row of display positions. For this second bottom most row, the symbol selector 620 selects the symbols: A, Q, 9, 10 and K (as illustrated in FIG. 8C). In this case, the outcome evaluator 630 evaluates the selected symbols and determines that none of the selected symbols correspond to a winning combination and accordingly, the prize awarder 640 does not make an award to the player.

FIG. 8D illustrates the next row of selected symbols. In this case, the outcome evaluator 630 evaluates another row of selected symbols and determines that the three “Q” symbols selected by the symbol selector 620 correspond to a new winning combination and another award is accordingly made by the prize awarder 640 to the player.

In FIG. 8E, the last row of display positions (being the upper most row of display positions) is simultaneously displayed. In this case, the outcome evaluator 630 evaluates the selected symbols and determines that the four selected “Q” symbols correspond to a new winning combination and a final award is made by the prize awarder 640 to the player.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of displaying selected symbols to a player in a game of the type wherein a plurality of symbols are selected from a set of symbols and a game outcome is determined based on the selected symbols, the method comprising:
displaying a plurality of rows of display positions;
displaying a representation of changing symbols in each display position of the plurality of rows of display positions;
selecting a plurality of symbols from a set of symbols for display in a first row of the plurality of rows of display positions; and
simultaneously displaying the selected symbols in the display positions of the first row of display positions while representations of changing symbols are being displayed in display positions other than the display positions of the first row of display positions.

2. A method as claimed in claim 1, wherein each row of display positions comprises a plurality of horizontally adjacent display positions.

3. A method as claimed in claim 1, further comprising making an award to the player when the selected symbols displayed in the first row of display positions correspond to a winning combination.

4. A method as claimed in claim 1, wherein displaying a plurality of rows of display positions comprises displaying three or more rows of display positions.

5. A method as claimed in claim 4, further comprising:
selecting a plurality of symbols from the set of symbols for display in a second row of the plurality of rows of display positions; and
simultaneously displaying the selected symbols in the display positions of the second row of display positions while representations of changing symbols are being displayed in display positions other than the display positions of the first and second rows of display positions.

6. A method as claimed in claim 1, wherein displaying a plurality of rows of display positions comprises displaying two rows of display positions.

7. A method as claimed in claim 6, further comprising:
selecting a plurality of symbols from the set of symbols for display in a second row of the plurality of rows of display positions; and
simultaneously displaying the selected symbols in the display positions of the second row of display positions.

8. A method as claimed in claim 5, further comprising:
selecting a row of display positions from the plurality of rows of display positions as the first row of display positions; and
selecting another row of display positions from the plurality of rows of display positions as the second row of display positions.

9. A method as claimed in claim 8, wherein the first and second rows of display positions are selected randomly from the plurality of rows of display positions.

10. A method as claimed in claim 8, wherein the first and second rows of display positions are selected from the plurality of rows of display positions based on a predetermined sequence.

11. A method as claimed in claim 5, wherein:
the plurality of rows of display positions are displayed one on top of another;
the first row of display positions comprises all the display positions of the bottom most row of the plurality of rows of display positions; and
the second row of display positions comprises all the display positions of the second bottom most row of the plurality of rows of display positions.

12. A method as claimed in claim 1, wherein the representation of changing symbols displayed in each display position is a representation of spinning symbols.

13. A method as claimed in claim 1, wherein the game is a spinning-reel type game.

14. A gaming system comprising:
a display for displaying a plurality of rows of display positions;
a representation display controller arranged to control the display to display a representation of changing symbols in each display position of the plurality of rows of display positions;
a symbol selector arranged to select a plurality of symbols from a set of symbols for display in a first row of the plurality of rows of display positions; and
a symbol display controller arranged to control the display to simultaneously display the selected symbols in the display positions of the first row of display positions while representations of changing symbols are being displayed in display positions other than the display positions of the first row of display positions.

15. A gaming system as claimed in claim 14, wherein each row of display positions comprises a plurality of horizontally adjacent display positions.

16. A gaming system as claimed in claim 14, further comprising:
an outcome evaluator arranged to evaluate whether or not the selected symbols for display in the first row of display positions correspond to a winning combination; and
a prize awarder arranged to make an award to the player when the selected symbols displayed in the first row of display positions correspond to a winning combination.

17. A gaming system as claimed in claim 14, wherein the display is arranged to display three or more rows of display positions.

18. A gaming system as claimed in claim 17, wherein:
the symbol selector is arranged to select a plurality of symbols from the set of symbols for display in a second row of the plurality of rows of display positions; and
the symbol display controller is arranged to control the display to simultaneously display the selected symbols in the display positions of the second row of display positions while representations of changing symbols are being displayed in display positions other than the display positions of the first and second rows of display positions.

19. A gaming system as claimed in claim 14, wherein the display is arranged to display two rows of display positions.

20. A gaming system as claimed in claim 19, wherein:
the symbol selector is arranged to select a plurality of symbols from the set of symbols for display in a second row of the plurality of rows of display positions; and
the symbol display controller is arranged to control the display to simultaneously display the selected symbols in the display positions of the second row of display positions.

21. A gaming system as claimed in claim 18, wherein the symbol selector is arranged to select a row of display positions from the plurality of rows of display positions as the first row of display positions, and to select another row of display positions from the plurality of rows of display positions as the second row of display positions.

22. A gaming system as claimed in claim 21, wherein the symbol selector is arranged to select the first and second rows of display positions randomly from the plurality of rows of display positions.

23. A gaming system as claimed in claim 21, wherein the symbol selector is arranged to select the first and second rows of display positions from the plurality of rows of display positions based on a predetermined sequence.

24. A gaming system as claimed in claim 18, wherein:
the display is arranged to display the plurality of rows of display positions one on top of another;
the first row of display positions comprises all the display positions of the bottom most row of the plurality of rows of display positions; and
the second row of display positions comprises all the display positions of the second bottom most row of the plurality of rows of display positions.

25. A gaming system as claimed in claim 14, wherein the representation of changing symbols displayed in each display position by the representation display controller is a representation of spinning symbols.

26. A game controller for a gaming system, the game controller configured to:
control a display to display a plurality of rows of display positions;
control the display to display a representation of changing symbols in each display position of the plurality of rows of display positions;
select a plurality of symbols from a set of symbols for display in a first row of the plurality of rows of display positions; and
control the display to simultaneously display the selected symbols in the display positions of the first row of display positions while representations of changing symbols are being displayed in display positions other than the display positions of the first row of display positions.

27. A game controller as claimed in claim 26, wherein each row of display positions comprises a plurality of horizontally adjacent display positions.

28. A game controller as claimed in claim 26, wherein the game controller is configured to make an award to the player when the selected symbols displayed in the first row of display positions correspond to a winning combination.

29. A game controller as claimed in claim 26, wherein the game controller is configured to control the display to display a plurality of rows of display positions by displaying three or more rows of display positions.

30. A game controller as claimed in claim 29, wherein the game controller is configured to:
select a plurality of symbols from the set of symbols for display in a second row of the plurality of rows of display positions; and
control the display to simultaneously display the selected symbols in the display positions of the second row of display positions while representations of changing symbols are being displayed in display positions other than the display positions of the first and second rows of display positions.

31. A game controller as claimed in claim 26, wherein the game controller is configured to control the display to display a plurality of rows of display positions by displaying two rows of display positions.

32. A game controller as claimed in claim 31, wherein the game controller is configured to:
select a plurality of symbols from the set of symbols for display in a second row of the plurality of rows of display positions; and
control the display to simultaneously display the selected symbols in the display positions of the second row of display positions.

33. A game controller as claimed in claim 30, wherein the game controller is configured to:
select a row of display positions from the plurality of rows of display positions as the first row of display positions; and
select another row of display positions from the plurality of rows of display positions as the second row of display positions.

34. A game controller as claimed in claim 33, wherein the first and second rows of display positions are selected randomly from the plurality of rows of display positions.

35. A game controller as claimed in claim 33, wherein the first and second rows of display positions are selected from the plurality of rows of display positions based on a predetermined sequence.

36. A game controller as claimed in claim 30, wherein:
the plurality of rows of display positions are displayed one on top of another;
the first row of display positions comprises all the display positions of the bottom most row of the plurality of rows of display positions; and
the second row of display positions comprises all the display positions of the second bottom most row of the plurality of rows of display positions.

37. A game controller as claimed in claim 26, wherein the representation of changing symbols displayed in each display position is a representation of spinning symbols.

38. A game controller as claimed in claim 26, wherein the game is a spinning-reel type game.

39. A gaming machine comprising:
a display for displaying a plurality of rows of display positions; and
a game controller comprising:
a representation display controller arranged to control a display to display a representation of changing symbols in each display position of the plurality of rows of display positions;
a symbol selector arranged to select a plurality of symbols from a set of symbols for display in a first row of the plurality of rows of display positions; and
a symbol display controller arranged to control a display to simultaneously display the selected symbols in the display positions of the first row of display positions while representations of changing symbols are being displayed in display positions other than the display positions of the first row of display positions.

40. A tangible computer readable medium comprising computer program code which, when executed, implements a method of displaying selected symbols to a player in a game of the type wherein a plurality of symbols are selected from a set of symbols and a game outcome is determined based on the selected symbols, the method comprising:
displaying a plurality of rows of display positions;
displaying a representation of changing symbols in each display position of the plurality of rows of display positions;
selecting a plurality of symbols from a set of symbols for display in a first row of the plurality of rows of display positions; and
simultaneously displaying the selected symbols in the display positions of the first row of display positions while representations of changing symbols are being displayed in display positions other than the display positions of the first row of display positions.
